(19) United States
(12) Patent Application Publication
(10) Pub. No.: US 2004/0049510 A1
(43) Pub. Date: Mar. 11, 2004

(54) Method of operating a plurality of electronic databases

(76) Inventors: Eric Minch, Sanhausen (DE); David Croft, Heidelberg (DE); Stefan Richter, Heldelberg (DE)

Correspondence Address: MCDERMOTT WILL & EMERY, 600 13TH STREET, N.W., WASHINGTON, DC, 20005-3096, US

(21) Appl. No.: 10/398,803

(22) PCT Filed: Oct. 16, 2001
(86) PCT No.: PCT/EP01/11989

(30) Foreign Application Priority Data
Dec. 20, 2000 (EP) 00127973.6

(51) Int. Cl. G06F 17/00

(52) U.S. Cl. 707/100

(57) ABSTRACT

A method of operating a plurality of electronic databases which can be accessed simultaneously by a user, said databases each comprising a search facility for records of the database, is characterized by providing one or more links from at least some data records of a first database to one or more records of at least a second database, performing a search in at least said first database and executing at least one of said links from at least one of the records forming the result of said search.

This invention relates to method of operating a plurality of electronic databases which each comprise a search facility for records of said database and which can be accessed simultaneously by a user.

Today's information technology and especially the internet provide users with a wealth of information in virtually every field of science and technology. Databases which can be accessed online by a user are available for almost every topic under the sun. Especially in rapidly progressing sciences as microbiology, research data are collected and kept up to date on a regular basis in electronic databases, thereby replacing written handbooks used in former times which were sometimes already outdated when they were published. The amount of information now available to a user, however, poses problems of its own. Databases are usually restricted to a specific problem or topic and relevant information may be contained in more than one database. If, for example, the role of certain compounds, e.g. non-macromolecular compounds, in biological processes is investigated, databases on compounds, proteins, taxa of organisms and reaction pathways, and, given the case, further subject matter, may have to be used to get a full picture of all the aspects involved. So far, a user has to start with one database, search e.g. for a certain compound, note down the search results and then access further databases to get additional information about biological processes in which this compound may play a role. This is a time consuming job which is also susceptible to oversights and mistakes when transferring the result of a search in one database to a query in another database.

It is the object of the present invention to facilitate the combined search in a plurality of databases.

According to the invention, this object is accomplished by a method of operating a plurality of electronic databases which can be accessed simultaneously by a user, said databases each comprising a search facility for records of said database, characterized by providing one or more links from at least some or the majority, preferably each data record of a first database to one or more records of at least a second database, said records of the first and second database being related in that at least one field of the record of the second database comprises a data element that is related to a data element of the corresponding record of the first database according to a predetermined relation, performing a search at least in said first database, executing at least one of said links of at least one of the records forming the result of said search in said database.

The invention may provide that a data record in said second database related by a link to a record in said first database is automatically accessed when executing said link. Thus, the access to the second database is not the immediate or direct result of the interaction of a user with the computer, such as by clicking a visualized link, but e.g. the result of other processing steps, such as the output of the result of the search in said first database, steps of processing the search result or also a selection of some of the search results by the user. Access of the second database may be part of a routine or a program package performing functions beyond the mere execution of a link. Said routine or program package may especially run in the background, at least as far as the access of the other database in executing the link or executing the entire link is concerned.

The invention may provide that said link is executed automatically, especially in consequence of the search.

The invention may provide that said link is executed in consequence of an operation on the search result, e.g. selecting one or more records from a search result comprising a plurality of records, with the consequence that said links are only executed for said selected records. Said link may also be automatically executed in response of a further command different from a command to execute the link.

The invention may especially provide that the links that are automatically executed are predetermined, e.g. by implementing the automatic execution in the first database or by providing the user with an interface for selecting the links to be executed prior to his search. For example, the invention may provide that only links from one or more specific fields of a record are automatically executed which are predetermined or previously chosen by user. The interface could, for example, be a menu listing links or groups of links to be selected by a user.

Additionally or alternatively the invention may provide that the first database comprises links to various databases and that the database to which links are to be executed automatically are predetermined prior to a search by the user using a suitable interface. It may also be provided that said links to a predetermined part of said databases are executed automatically.

The relation between the data elements of the first and of the second database may be identity in the simplest case, i.e. the same data element is present in both records. Another simple relation may be that the data element in the record of the second database is assigned to the data element in the record of the first database by a one-to-one relationship, e.g. agonist/antagonist, receptor/ligand, sequence/structure etc. One of said data elements may especially be a key of the data record of the first or the second database. In a simple case the relation between the two records is that the data forming a key of the record of the first database are contained in the record of the second database or vice versa.

In this context “link” means any navigational device, connection or method utilized to move between pieces or groups of information, which includes, but is not limited to hyperlinks.

The invention may provide that said link is a pre-established link.

In this case the link may specify or point directly to the address of a record in the second database.

The link from said record need not be permanently established or existing in the sense that there is a pointer pointing to a specified address. Rather, a link in the sense of this application may also be provided by providing program code creating such a pointer on the basis of a certain input, e.g. a search result, or creating data specifying an address to be used with a pointer. Thus, the link between the two databases may also be a link created instantaneously and automatically, e.g. as the result of a search in the first database.

Preferably, said link or links are established such that information related to said record forming the whole or part of said search result of said search is accessed by the execution of said link.

In an embodiment of the invention a search query for another database is generated by the computer from the result of a first search in one of said databases, either automatically or, given the case, e.g. in response to a command of the user to provide further information, and said search query is automatically executed to carry out a search in said other database. In this embodiment, the access to the second database is performed by executing said second search query in said other database, wherein said access to the second database by said second query is triggered by a previous processing step, namely the generation of a search query for the second database. Generation of said search query may be directly initiated by a user. However, the consequent access to the other database after the automatic generation of said query is performed automatically without further interaction by the user. Generating and executing said search query is suitably done under SRS. Details about SRS can be found e.g. under http://srs.ebi.ac.uk.

The invention especially provides a method of operating a plurality of electronic databases which can be accessed simultaneously by a user, said databases each comprising a search facility for records of the database, said method comprising:

providing one or more links from at least some data records of the first database to one or more records of at least a second database,

performing a search in at least said first database,

generating a search query to be performed in a second database on the basis of the result of said search in said first database and

automatically executing said search query in said second database upon generation of said search query for said other database.

Said search query in said other database may be automatically executed or executed upon command of the user that he wishes to have this query executed. The search query itself need not necessarily be displayed. For example, by clicking a search result the user may indicate that he wishes further information from another database.

It may also be provided that the result of said first search is entered as a search parameter into said search query for said other database.

For example, if the first search returns the name of a substance, this name is entered into a preformulated search query for a record of said other database which is then executed. The invention may also provide that said result of said first search is further processed to generate a parameter for said further search.

The invention may provide that links from said first database are provided to more than one other database, especially, given the case, all other databases. Vice versa, a plurality of databases, especially all databases, may be provided with links, as specified above, to one or more other databases.

The method according to the invention may also comprise the step of simultaneously outputting a search result of said first search and an output resulting from the execution of a link related to said search result. The method according to the invention may especially comprise the step of simultaneously outputting the search result both of said first search in said first database and of said further search in said other database or databases.

Said output can especially be effected by a display on a screen. For example, each database may be assigned to a separate window and the search result related to a specific database is displayed in the window assigned to said database. The user can then study and compare the result of searches in the various databases.

In an embodiment of the invention the search result of related searches in a plurality of databases is combined into one single output.

For example, a specific result window may be created on a display, listing the result of said first search and of any further search initiated by said first search, which may be edited to create a document providing a comprehensive response to an initial question. For example, if a query in a first database relates to a certain class of substances, the output may comprise in a first section or paragraph the name of the substance found and chemical information related to said substance, a list of the biological reactions related to said substance in a second section or paragraph and of the proteins related to reactions involving said substance or the synthesis of said substance in a third section or paragraph.

Of course, the output need not necessarily be on a display, but may also be a printed document, an electronic file, an e-mail or the like.

It may also be provided that a user is presented a list of search results and upon selection of one or more of these search results by a user a link to another database from said selected search results, especially by generating a search query for another database, is automatically generated.

Thus, the user may choose on which of the search results he wishes to have additional information, thereby avoiding the display or output of irrelevant information. Having received information regarding one search result, he may select another search result and the result of searches related to said newly selected search result will be displayed or output.

It may be provided that only such records, especially such results of said further search, are displayed or otherwise output that relate to a link, especially a search, the execution of which was initiated by the presently selected result of said first search. For example, the first search might retrieve all enzymes involved in the catalysis of reactions of a certain compound (e.g. cholesterol), and the second search could retrieve all organisms (e.g. humans, yeast) known to have genes encoding one or more or all of these enzymes (e.g. sterol esterase, steryl-beta-glucosidase, etc.).

The invention may provide that the result of said first search is used for generating a search query for a plurality of other databases, especially for queries in all other databases.

The invention may also provide that the search result of said other search is used to generate a search query for a third search.

This third search may be in a further database or in the database in which the first or second search was carried out. To continue the above example, the third search may retrieve a specific metabolic pathway (e.g. bile acid synthesis) in one or more or all of the organisms retrieved as a result of the second search.

More generally, the invention may provide that after execution of said link to a further database in consequence of a search, a further link from the target record of said further database is executed, especially to the first database in which said search was carried out or to a still further database.

According to an embodiment of the invention, the search results of a plurality of searches are used to generate search queries for a further search. Thus, the result of several searches is combined to formulate a further search.

Said further search may be in the same or a different database from those in which previous searches were carried out.

The invention may provide that at least two databases related to each other by at least one link relate to different subject matter. The invention may especially be applied to cases where the output of one database cannot be used as a direct input to another database.

It may be provided that at least one of the databases relates to compounds and a further database relates to one of proteins, taxa, text documents or reaction pathways. “Taxon” is understood to mean a taxonomic group of any rank, e.g. species, family, order or class.

The invention also provides a computer system capable of accessing a plurality of databases, each of which comprises a search facility, characterized by means for carrying out the steps of one of the methods set out above, especially according to claims 1 to 11.

The invention also provides a computer program performing, when executed on a computer, the following steps:

receiving a search result from a first database,

executing a link from said result to a second database,

The invention also provides a computer program as set out above, performing, when executed on a computer, the following steps:

automatically generating a search query for a second database on the basis of said search result,

initiating a search in said second database according to said search query.

The computer program according to the present invention may cause a computer to carry out further or all steps of a method as set out above, when executed on said computer, especially steps of outputting, e.g. displaying, information, search results and the like. The program may also cause the steps of carrying out searches to be executed on said computer.

Generally, the databases may be installed in one single computer system or may be distributed on a plurality of computer systems which can be accessed by the computer system employed by a user inputting a search query.

The invention also provides a computer readable medium comprising data readable by a computer, said data comprising a program as set out above, especially according to claim 13 or 14.

Said computer readable medium may especially comprise executable program code for executing a program and/or performing a method as set out above.

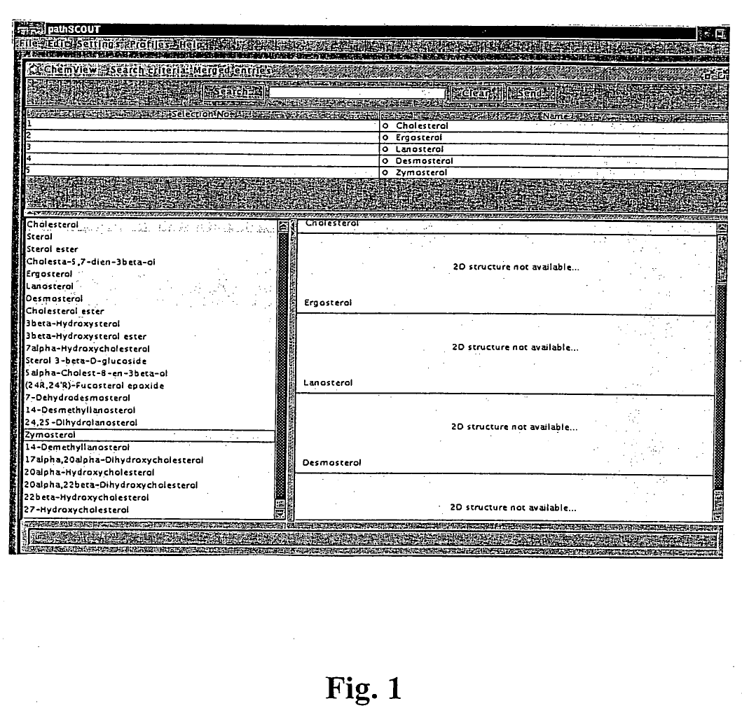

The invention is further illustrated by the following example chosen from the field of biology with reference to enclosed FIGS. 1 to 4 showing exemplary screen shots illustrating stages of said example of a method according to the invention.

FIG. 1 illustrates the result from a search in a compound database,

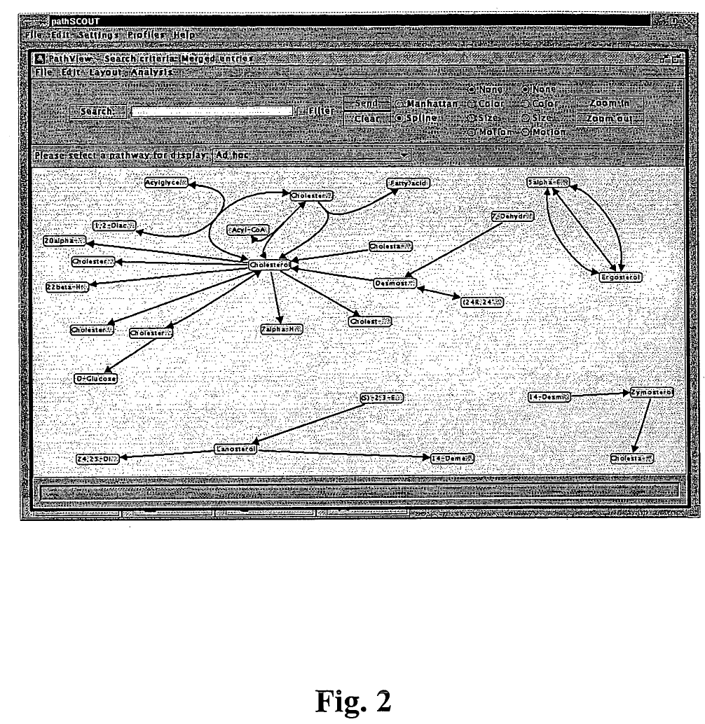

FIG. 2 illustrates the result from a search in a subsequent reaction database,

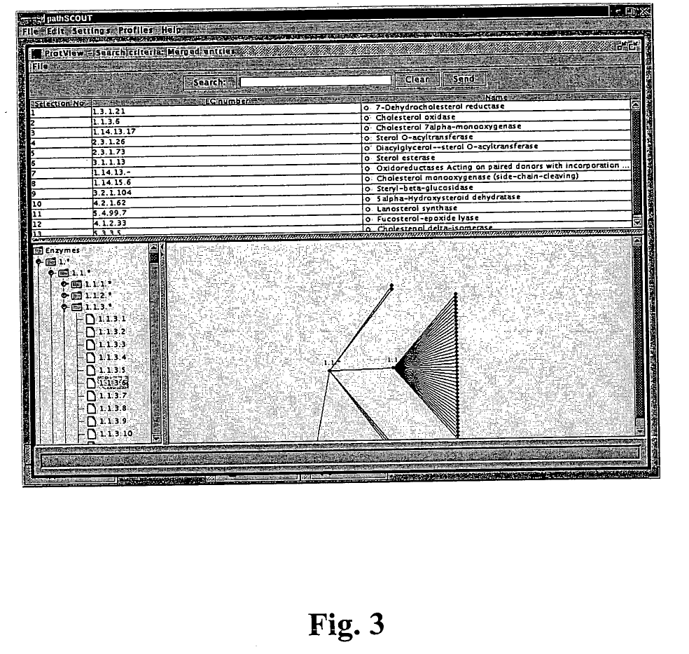

FIG. 3 illustrates the result of a subsequent search in a protein database and

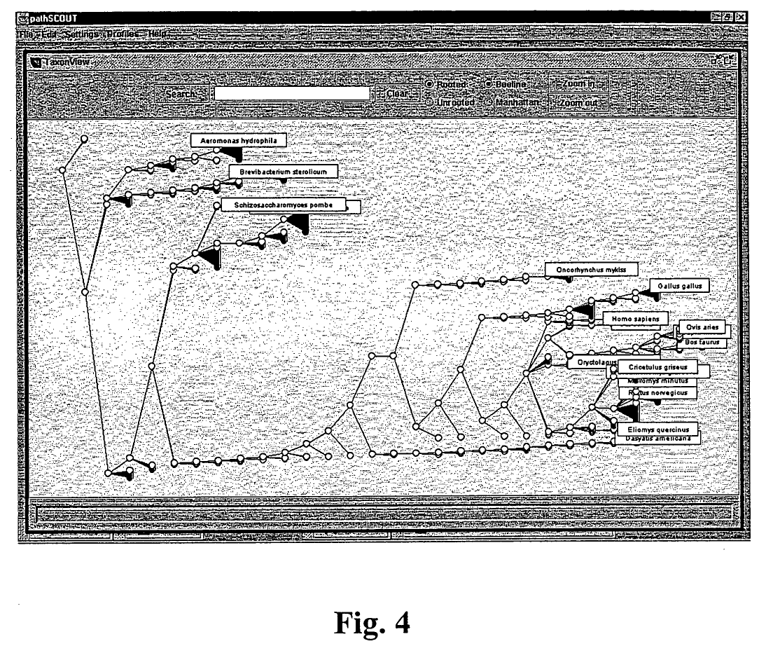

FIG. 4 illustrates the results of a search of a subsequent search in a taxonomy database.

A user is provided with a user interface giving him access to a plurality of databases, which may be related to e.g. compounds, proteins, taxa and biological reaction pathways. Each database is assigned to a window displaying the results of searches in this database. The user is also provided with a mask or another input facility to input queries to one or more of these databases, which may be provided in the respective window assigned to the relevant database or which may be formed by a separate window for inputting queries for one, several or all databases.

A user e.g. interested in gathering information about certain sterols, will type in a query related to sterols for the database on compounds which will e.g. return the substance cholesterol and chemical information related thereto. From the user's point of view, he has simply typed the string “*sterol*” into the text field of the window dedicated to the database of compounds. The system, however, responds by issuing the SRS query

“getz‘[lcompound-nam:*sterol*]’”

to the SRS database of compounds, and the SQL query

“select id from compounds where name like ‘%sterol%’”

to the Oracle database of compounds. In the above-mentioned getz-command “lcompound” designates a database and “-nam” a field in this database. The combined result yields the records for the following 25 different compounds or compound families shown in FIG. 1 (listing here only the names):

Cholesterol

Sterol

Sterol ester

Cholesta-5,7-dien-3beta-ol

Ergosterol

Lanosterol

Sitosterol

Campesterol

Desmosterol

Cholesterol ester

3beta-Hydroxysterol

3beta-Hydroxysterol ester

7alpha-Hydroxycholesterol

Sterol 3-beta-D-glucoside

5alpha-Cholest-8-en-3beta-ol

(24R,24′R)-Fucosterol epoxide

4alpha-Methylzymosterol

7-Dehydrodesmosterol

14-Desmethyllanosterol

24,25-Dihydrolanosterol

Zymosterol

14-Demethyllanosterol

Phytosterol

17alpha,20alpha-Dihydroxycholesterol

20alpha-Hydrokycholesterol

20alpha,22beta-Dihydroxycholesterol

22beta-Hydroxycholesterol

27-Hydroxycholesterol

7-alpha,27-Dihydroxycholesterol

Dihydrotachysterol

Benzalkonium chloride

Either without any further interaction, or by preference with a simple button press, the system now initiates further queries in the databases on reaction pathways for processes involving these sterols. In the preferred case, the user may select a subset of the results from the initial query before requesting the further automated queries. If e.g. the user has selected only the eight compounds cholesterol, ergosterol, lanosterol, sitosterol, campesterol, desmosterol, zymosterol, and phytosterol, then the system automatically generates the SRS query:

“getz‘[lionpath-reactant:c00187|c01694|c01753|c01789|c01802|c05437|c05442]’”

for the SRS reaction database, and the SQL query:

“select id from reactions where reactant in (‘c00187’, ‘c01694’, ‘c01753’, ‘c01789’, ‘c01802’, ‘c05437’, ‘c05442’)”

for the Oracle reaction database, using the database IDs of the compounds to retrieve the reactions in which they are involved. Again “lionpath” designates a database and “-reactant” a field. This yields the 23 reactions displayed in FIG. 2. In addition, the protein databases are similarly queried to retrieve the 13 enzymes (E.C. numbers 1.1.3.6, 1.3.1.21, 1.14.13.-, 1.14.13.17, 1.14.15.6, 2.3.1.26, 2.3.1.73, 3.1.1.13, 3.2.1.104, 4.1.2.33, 4.2.1.62, 5.3.3.5, and 5.4.99.7) catalyzing these reactions, displayed in FIG. 3. This is equivalent to the following SRS query:

“getz‘[lionpath-reactant:c00187|c01694|c01753|c01789|c01802|c05437|c05442]>lenzyme’”

Finally, a further SRS query equivalent to the following:

“getz‘[lionpath-reactant:c00187|c01694|c01753|c01789|c01802|c05437|c05442]>lenzyme>enzyme>taxonomy’”

is sent to the taxonomy database, to identify the taxa for which these biological processes are relevant, retrieving the 19 species shown in FIG. 4 (Aeromonas hydrophila, Brevibacterium sterolicum, Schizosaccharomyces pombe, Saccharomyces cerevisiae, Oncorhynchus mykiss, Gallus gallus, Homo sapiens, Sus scrofa, Bos taurus, Capra hircus, Ovis aries, Oryctolagus cuniculus, and Cricetulus griseus). “lenzyme”, “enzyme” and “taxonomy” designate databases in the above-mentioned command “getz”.

The results of all these searches will be displayed in the respective windows (FIGS. 1 to 4). As a result, the user will be provided with information about the sterol substances, the biological reactions involving them, the proteins related to sterol metabolism, and the taxa for which sterols are metabolically relevant. Instead of displaying the related information in different windows, all information may be displayed in one window which may be suitably structured, e.g. as a tabular report.

In a more refined embodiment, the user will be provided with a list for search results. Choosing one of the search results will result in a further query in the other databases. The user may then choose from the list of results of this further query a specific result which is then processed to formulate a query for the other databases. This way, the user remains in control over the information displayed.

Although in the preferred embodiment the user is provided with additional information automatically as a consequence of his first search without further interaction with the computer, the invention may also provide that the number of databases that can be combined in such a unitary search process is variable so that the user can define from which further database he wishes to receive additional information. Likewise the invention may provide that he can define which fields of the database shall be used to formulate a query for the other databases.

The features of the invention disclosed in the claims and the specification, taken individually or in any combination thereof, may be material for the realisation of the invention in its various embodiments.

1. Method of operating a plurality of electronic databases which can be accessed simultaneously by a user, said databases each comprising a search facility for records of the database,
characterized by providing one or more links from at least some data records of a first database to one or more records of at least a second database,
performing a search in at least said first database,
executing at least one of said links from at least one of the records forming the result of said search, wherein a data record in said second database related to a record in said first database by a link is accessed automatically.

2. Method according to claim 1, characterized in that at least one of said links between the two databases is a link created instantaneously.

3. Method according to one of claims 1 or 2, characterized in that on the basis of the result of a first search in one of said databases a search query for another database is automatically generated and said search query is executed to carry out a search in said other database.

4. Method according to claim 3, characterized in that the result of said first search is entered as a search parameter into said search query for said other database.

5. Method according to one of claims 1 to 4, characterized in that at least part of the record forming a result of said search in said first database and an output resulting from executing a link from said record to a second database are output simultaneously.

6. Method according to one of claims 4 to 5, characterized in that the search result of related searches in a plurality of databases are combined into one single output.

7. Method according to one of claims 1 to 6, characterized in that a user is presented a list of records as a result of the search and upon selection of one or more of these search results by a user a link to another database from said selected search results is automatically executed.

8. Method according to claim 7, characterized in that only such records are output that relate to a link the execution of which was initiated by the presently selected record forming the result of said first search.

9. Method according to one of claims 4 to 8, characterized in that the search result of said other search is used to generate a search query for a third search.

10. Method according to one of claims 1 to 9, characterized in that the search results of a plurality of searches are used to generate one or more search queries for a further search.

11. Method according to one of claims 1 to 10, characterized in that at least two of the databases relate to different subject matter, said subject matter being one of compounds, proteins, genes, taxa, text documents or reaction pathways.

12. Computer system capable of accessing a plurality of databases, each of which comprises a search facility, characterized by means for carrying out the steps of one of the methods according to claims 1 to 11.

13. Computer program performing, when executed on a computer, the following steps:
receiving a search result from a first database,
automatically executing a link from said result to a second database,

14. Computer program according to claim 13, performing, when executed on a computer the following steps:
automatically generating a search query for a second database on the basis of said search result,
initiating a search in said second database according to said search query.

15. Computer readable medium comprising data readable by a computer, said data comprising a program according to claim 13 or 14.
